(19) United States
(12) Patent Application Publication
(10) Pub. No.: US 2004/0070784 A1
(43) Pub. Date: Apr. 15, 2004

(54) Methods, computer media and devices for processing compressed data intended for printing

(76) Inventor: Terrence M. Shannon, Kuna, ID (US)

Correspondence Address: HEWLETT-PACKARD COMPANY, Intellectual Property Administration, P.O. Box 272400, Fort Collins, CO, 80527-2400, US

(21) Appl. No.: 10/269,493

(22) Filed: Oct. 11, 2002

(51) Int. Cl. G06F 3/12; G06F 13/00

(52) U.S. Cl. 358/1.15; 358/1.16

(57) ABSTRACT

Methods and systems for processing compressed data that is intended for printing are described. In accordance with one embodiment, a method ascertains one or more attributes associated with raster data that is intended for printing on a printer. The raster data is compressed to provide a compressed raster data block. A tag is associated with the compressed raster data block. The tag embodies one or more attributes, where at least one of the attributes is of a type such that without the tag, the printer would have to decompress the compressed raster data block in order to ascertain the attribute(s).

### TECHNICAL FIELD

This invention relates generally to printers and, more particularly, to methods and systems for processing compressed data intended for printing.

### BACKGROUND

In the printing environment, the printer is typically connected to a host computer. Before a printer can do anything else, it needs to receive the page data and figure out how it is going to put everything on the paper. This is typically the job of the printer controller. The printer controller is the printer's main onboard computer. It communicates to the host computer through a communications port, such as a parallel port or USB port. At the start of the printing job, the printer establishes with the host computer how they will exchange data.

For the printer controller and the host computer to communicate, they typically need to speak the same page description language. To enable host computers and printers to communicate with one another, advanced printer languages called page description languages or PDLs have evolved. Today, the primary printer languages are Hewlett Packard's Printer Command Language (PCL) and Adobe's Postscript. Both of these languages describe the page in vector form—that is, as mathematical values of geometric shapes, rather than as a series of dots (a bitmap image). The printer itself typically takes the vector images and converts them into a bitmap page. With this system, the printer can receive elaborate, complex pages, featuring any sort of font or image.

Some printers use a raster format instead of a full-featured PDL. In this system, the host computer creates the dot array itself, so the controller does not have to process anything—it just sends the dot instructions on to the laser—in the case of a laser printer.

But in most laser printers, the controller organizes all of the data it receives from the host computer. This includes all of the commands that tell the printer what to do—what paper to use, how to format the page, how to handle the font, etc. For the controller to work with this data, it has to get it in the right order.

Once the data is structured, the controller begins putting the page together. It sets the text margins, arranges the words and places any graphics. When the page is arranged, the raster image processor (RIP) takes the page data, either as a whole or piece by piece, and breaks it down into an array of tiny dots. The printer uses the page in this format so that the laser can write it out on the photoreceptor drum. In most laser printers, the controller saves all print-job data in its own memory. This lets the controller put different printing jobs into a queue so it can work through them one at a time. It also saves time when printing multiple copies of a document, since the host computer only has to send the data once.

Often times a print job that is processed on a host computer will contain raster data that is associated with images or other objects on a page that is to be printed. Raster data can be considered as data that is sent by the host computer when translated into a graphical version that can be understood by the printer. Consider, for example, a photograph that is desired to be sent to a printer for printing. Typically, on the host computer, a software application, the operating system, and the printer driver will work cooperatively to convert the photograph into raster data or a raster image. Raster data or a raster image can typically be very large such that it is simply not good practice to send the raster data in an decompressed state over the I/O channel to the printer. Accordingly, raster data is typically compressed in the appropriate PDL with a compression method that the PDL understands. The compressed raster data is then sent over the I/O channel to the printer for further processing.

On the printer side, the compressed raster data is received by a PDL parser which understands the PDL. The parser is able to ascertain that the received data stream is compressed raster data and then typically stores the compressed raster data somewhere in the printer's memory until it is needed.

During normal printer operations, there can be instances that arise when the compressed raster data has to be decompressed and operated upon by the printer in some manner. For example, if the printer is running low on memory, it might access the compressed raster data, decompress it, perform some optimization on it, recompress it and store it back in memory to free up some memory. Alternately, the printer may need to do some pre-printing processing that requires it to decompress the compressed raster data. However, until the printer initially decompresses the compressed raster data, it typically does not know a great deal about the decompressed raster data. Once decompressed, the printer can perform its operations on the raster data to prepare it for printing. When this is done, quite often the raster data will be compressed again before it is sent to the ASIC that modulates the laser.

Having to decompress and recompress raster data can contribute a great deal to the printer's overhead. It would be desirable to find a way to reduce the amount of decompression/recompression operations that take place on the printer. By doing so, printers could be made to operate more simply and with less overhead.

Accordingly, this invention arose out of concerns about processing compressed data that is intended for printing.

### SUMMARY

In accordance with one embodiment, a method ascertains one or more attributes associated with raster data that is intended for printing on a printer. The raster data is compressed to provide a compressed raster data block. A tag is associated with the compressed raster data block. The tag embodies one or more attributes, where at least one of the attributes is of a type such that without the tag, the printer would have to decompress the compressed raster data block in order to ascertain the attribute(s).

In another embodiment, a printer driver is provided and is configured to ascertain one or more attributes associated with raster data that is intended for printing on a printer. The printer driver effects compression of the raster data to provide a compressed raster data block and associates, with the compressed raster data block, a tag that embodies the attribute(s). At least one of the attributes is of a type such that without the tag, the printer would have to decompress the compressed raster data block in order to ascertain the attribute(s).

In yet another embodiment, a printer comprises one or more processors, memory, and instructions stored in the memory which, when executed by the one or more processors, cause the processor(s) to receive, with the printer, at least one compressed raster data block and an associated tag. The tag embodies one or more attributes associated with decompressed raster data that corresponds to the one compressed raster data block. At least one of the attributes is of a type such that without the tag, the printer would have to decompress the compressed raster data block in order to ascertain the attribute(s). Without decompressing the one compressed raster data block, the printer ascertains attributes of the decompressed raster data using the tag, and stores the compressed raster data block in memory until the compressed raster data block is needed.

### BRIEF DESCRIPTION OF THE DRAWINGS

FIG. 1 is a block diagram of an exemplary printing system in connection with which one or more embodiments can be implemented.

FIG. 2 is a block diagram of an exemplary host computer that can be utilized to implement one or more embodiments.

FIG. 3 is a block diagram that diagrammatically represents one embodiment.

FIG. 4 is a flow diagram that describes steps in a method in accordance with one embodiment.

### DETAILED DESCRIPTION

Overview

Methods, computer media and devices for processing compressed data intended for printing are described. In accordance with one or more of the described embodiments, raster data is compressed externally of a printer on which the raster data is to be used to effect printing. Typically, compression of the raster data takes place in a printer driver that is resident on a host computer that is connected to the printer. As part of the compression processing, individual tags or headers are associated with individual portions of the compressed raster data. The individual tags contain, among other things, information or attributes about the raster data that is useful to the printer. Using the tags, the printer can gain knowledge about the compressed raster data and can make processing decisions without having to decompress and recompress the compressed raster data. By eliminating, in some instances, the need for the printer to decompress and recompress the compressed raster data, the overall operational efficiency of the printer can be improved.

Exemplary Printing Device

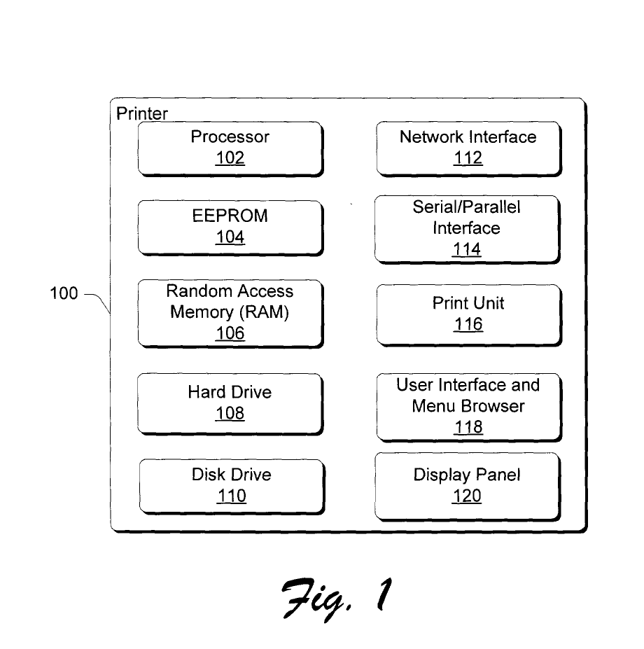

FIG. 1 is a block diagram showing exemplary components of a printing device in the form of a printer 100 that can be used in accordance with the described embodiments. While FIG. 1 illustrates a specific type of printing device, it should be appreciated that other printing devices such as facsimile machines, copiers, and the like can be utilized without departing from the spirit and scope of the claimed subject matter. In addition, the term “printer” and “printing device” are used interchangeably in this document and, as used, will be understood to include multi-function devices that, in addition to printing, perform additional functions. Such additional functions can include, without limitation, one or more of the following: faxing, copying, scanning and the like.

Printer 100 includes a processor 102 and at least one computer-readable media. In this example, the computer readable media can include an electrically erasable programmable read-only memory (EEPROM) 104 and a random access memory (RAM) 106. Further, the computer-readable media can include hard drive 108. Processor 102 processes various instructions necessary to operate the printer 100 and communicate with other devices. EEPROM 104, RAM 106, and/or hard drive 108 can store various information such as configuration information, fonts, templates, data being printed, and menu structure information.

In addition, although not shown in FIG. 1, a particular printer may also contain a ROM (non-erasable) in place of or in addition to EEPROM 104. Furthermore, a printer may alternatively contain a flash memory device in place of or in addition to EEPROM 104.

Printer 100 also includes a disk drive 110, a network interface 112, and a serial/parallel interface 114. Disk drive 110 provides additional storage for data being printed or other information used by the printer 100. Although both RAM 106 and disk drive 110 are illustrated in FIG. 1, a particular printer may contain either RAM 106 or disk drive 110, depending on the storage needs of the printer. For example, an inexpensive printer may contain a small amount of RAM 106 and no disk drive 110, thereby reducing the manufacturing cost of the printer.

Network interface 112 provides a connection between printer 100 and a data communication network. Network interface 112 allows devices coupled to a common data communication network to send print jobs, menu data, and other information to printer 100 via the network. The network interface can be embodied as a network server and, more particularly, as a Web server. As a network server or Web server, the network interface can enable a user to access the printer using standard network protocols. For example, as a Web server, the network interface can enable two-way communication with one or more clients via standard network protocols such as TCP/IP.

Serial/parallel interface 114 can also provide a data communication path directly between printer 100 and another device, such as a workstation, server, or other computing device. Although the printer 100 shown in FIG. 1 has two interfaces (network interface 112 and serial/parallel interface 114), a particular printer may only contain one interface.

Printer 100 also includes a print unit 116 that includes mechanisms that are arranged to selectively apply ink (e.g., liquid ink, toner, etc.) to a print media (e.g., paper, plastic, fabric, etc.) in accordance with print data within a print job. Thus, for example, print unit 116 can include a conventional laser printing mechanism that selectively causes toner to be applied to an intermediate surface of a drum or belt. The intermediate surface can then be brought within close proximity of a print media in a manner that causes the toner to be transferred to the print media in a controlled fashion. The toner on the print media can then be more permanently fixed to the print media, for example, by selectively applying thermal energy to the toner. Print unit 116 can also be configured to support duplex printing, for example, by selectively flipping or turning the print media as required to print on both sides. The print unit 116 can also comprise an ink jet print unit that utilizes principles of ink jet printing. Those skilled in the art will recognize that there are many different types of print units available, and that for the purposes of the present discussion, print unit 116 can include any of these various types.

Printer 100 can also contain a user interface/menu browser 118 and a display panel 120. User interface/menu browser 118 allows the user of the printer to navigate the printer's menu structure. User interface 118 may be a series of buttons, switches or other indicators that are manipulated by the user of the printer. Display panel 120 is a graphical display that provides information regarding the status of the printer and the current options available through the menu structure.

The illustrated printer can, and typically does include software that provides a runtime environment in which software applications or applets can run or execute. The runtime environment can facilitate the extensibility of the printer by allowing various interfaces to be defined that, in turn, allow applications or applets to interact with the printer in more robust manners.

It will be appreciated that the inventive techniques and methods described herein include all forms of computer-readable media when such media contains instructions which, when executed by a processor or computer, implement the techniques and methods.

Exemplary Host Computer

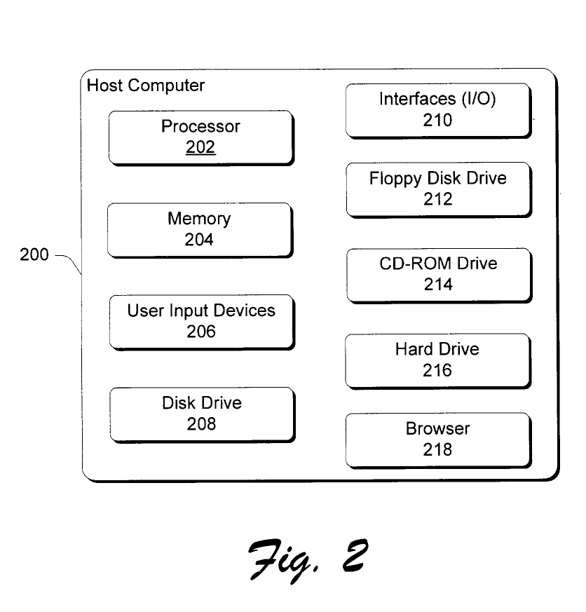

FIG. 2 is a block diagram showing exemplary components of an exemplary host computer 200. Computer 200 includes a processor 202, a memory 204 (such as ROM and RAM), user input devices 206, a disk drive 208, interfaces 210 for inputting and outputting data, a floppy disk drive 212, and a CD-ROM drive 214. Processor 202 performs various instructions to control the operation of computer 200. Memory 204, disk drive 208, floppy disk drive 212, CD-ROM drive 214 and/or a hard drive 216 can provide data storage mechanisms. User input devices 206 include a keyboard, mouse, pointing device, or other mechanism for inputting information to computer 200. Interfaces 210 provide a mechanism for computer 200 to communicate with other devices. Client 200 can also include a browser 218 that can allow a user to browse the Web. Exemplary browsers can include Microsoft's Internet Explorer or Netscape's Navigator.

Computer 200 also includes one or more print drivers that, together with software applications and the host computer's operating system, cooperate to provide print job data over the I/O 210 to the printer for printing.

Exemplary Embodiment

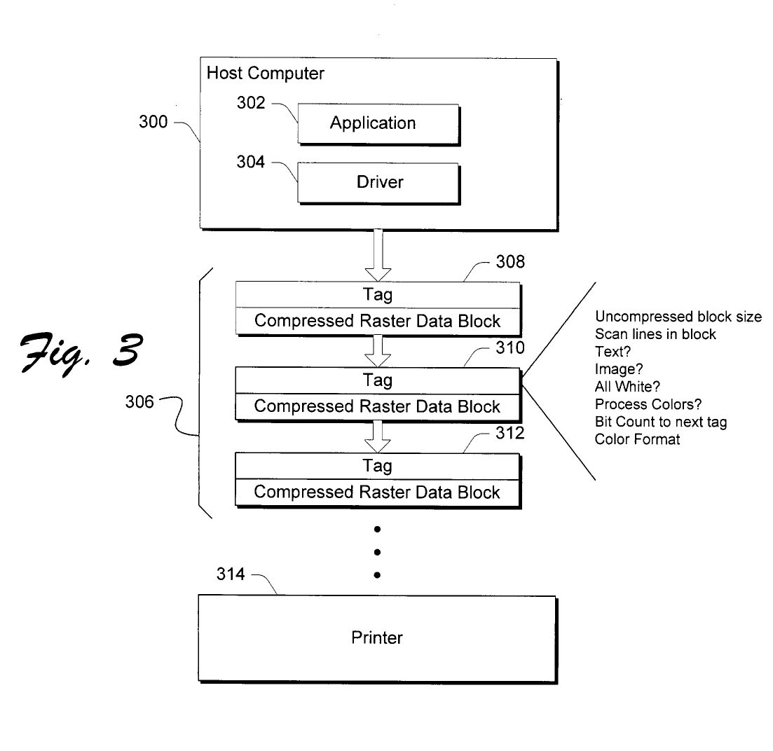

FIG. 3 illustrates an exemplary system in which various inventive principles described herein can be employed. In this example, a host computer 300 includes one or more applications 302 and one or more printer drivers 304. Application 302 enables the user to select data that is intended for printing on printer 314, and can comprise any suitable application that is typically used by a user to select data for printing. Examples include, without limitation, word processing applications, computer graphics applications, browser applications and the like. When the user selects that data that is intended for printing, a printer driver receives the data and processes it into a format that can be understood by the printer. Typically the driver comprises software code that utilizes a printer description language (PDL) to process the data. Part of the processing that can take place on the host computer is that the data that is intended for printing can be processed into raster data. Components of the host computer, including the driver, can then compress the data to provide one or more compressed raster data blocks.

In accordance with one embodiment, before or during the compression processing, the driver 304 can further process the data to ascertain attributes about the data. These attributes are the kinds of attributes that can be utilized by the printer to enable the printer to become knowledgeable about the decompressed raster data, without having to physically decompress the compressed raster data block. The driver 304 then provides the attributes that it ascertains (or indicia of the attributes) into a tag or header that is then associated with the compressed raster data block. For purposes of this document, the act of providing attributes into a tag or header includes the act of providing indicia of the attributes into the tag or header. The association of the compressed raster data blocks and their individual tags define an array 306 of individual tag/block pairs 308, 310, and 312 which are then sent or otherwise transmitted to printer 314 for processing.

By virtue of the attributes contained in the tags, the printer can ascertain information about the associated decompressed raster data without having to physically decompress and recompress the compressed raster block. Accordingly, the printer can store the compressed raster block(s) and their associated tags (if desired) in memory until the block is needed for further processing. Advantageously, in some examples, the compressed raster data block can remain compressed until is it actually needed for printing.

Exemplary Data Attributes

The attributes that are included in the individual tags can comprise any suitable attributes that might be desirable for the printer to become knowledgeable of without having to decompress the compressed raster data blocks. As but a few examples of the types of attributes that can be included in a tag, consider the following.

One attribute that can be included in the tag is the decompressed block size of the block in terms of its width and height. Additionally, the x and y coordinates of an image can also be provided in the tag. This way, the printer knows ahead of time the size and location of the raster data that is associated with the compressed block. Another attribute that can be included in the tag is the number of scan lines in the block. This provides the printer with information on the dimensionality of the block ahead of time.

Other attributes that can be included in the tag are whether or not the block contains text or image data, whether the block contains all white, and whether the block contains process colors. This can be advantageous for the following reason. Suppose that the rasterized data that is compressed is a photograph versus a piece of text such as the letter “T”. If the printer is a high end color printer, it may then want to know the difference between the letter and the photograph so that it can make a decision as to how to handle the color processing when it comes to processing the color black. Specifically, with the piece of text, black toner or “toner black” is typically used for the black color; with the photograph, however, so-called “process black” is used. Process black is typically made by combining the other colors of the toner. This results in a different color of black that smoothly blends in with the rest of the photograph.

Other attributes that can be included in the tag are the byte count to locate the next tag and the color format (e.g. CMY, CMYK, RGB, C, M, Y, K). The byte count attribute describes how far the printer has to jump ahead to find the next tag. Having this attribute can result in economies on both the driver and the printer side. Specifically, consider the case of the driver. One of the things that can be advantageous for the printer to know is the byte count of the decompressed and compressed raster data. For the driver to provide this information, the driver first needs to process and compress the raster data. Suppose that the entire page is a raster image. By having tags that include a byte count to the next tag, the driver can process only a portion of the raster image, tag it, send it and then move on to process the next portion of the raster image. This avoids the printer driver having to process and compress the entire raster image before sending it to the printer. This can be particularly advantageous in the case of a resource-poor host computer where there may not be enough memory to compress and buffer the entire raster image.

Now consider the case of the printer. By knowing the byte count to the next tag, the printer can jump ahead for processing purposes. Suppose, for example, the printer wants to print all of the characters that are not process black. The state of the art now is that this cannot occur without decompressing and performing extra processing. Using the inventive tags, however, the printer can jump ahead and look at the tags that are associated with the blocks that it has received. From the tags, it can ascertain which blocks of compressed data contain the black which is not process black. It can then decompress the appropriate blocks and preprint all of the black that is not process black. This enables the printer to process things out of the order in which they are received without decompressing the image.

As another example, consider the case of a printer that prints in CMYK. The printer may desire to pull out and process all of the raster data in the C color plane. By having tags that describe color format attributes, the printer can look ahead to locate the appropriate compressed blocks that contain C data and process them accordingly. Presently, the state of the art in some printers is such that the color plane processing typically takes place in the driver where the driver has to send all of the C data to the printer first, then the M data, then the Y data, and finally the K data. Using the inventive tags, processing is not only enhanced on the printer side by enabling the printer to deserialize its processing, but the driver processing can be simplified because the driver need not make multiple passes to serially separate and send in the individual color data.

As another example of how various attributes can facilitate processing on the printer side, consider the following. Assume that a page that is to be printed contains no text until about half way down the page. That is, the top half of the page is white, followed by the text. The driver could, as it processes the page, compress all of the white space in addition to the text and send all of the compressed data to the printer for processing. Alternately, when the driver notices that it is processing a number of white lines, it can take steps to indicate the amount of white space in a tag that is associated with the compressed data that is sent to the printer. This can, in some instances, reduce the amount of compression work that the driver has to do and, correspondingly, can reduce the amount of decompression work that the printer has to do.

Exemplary Method

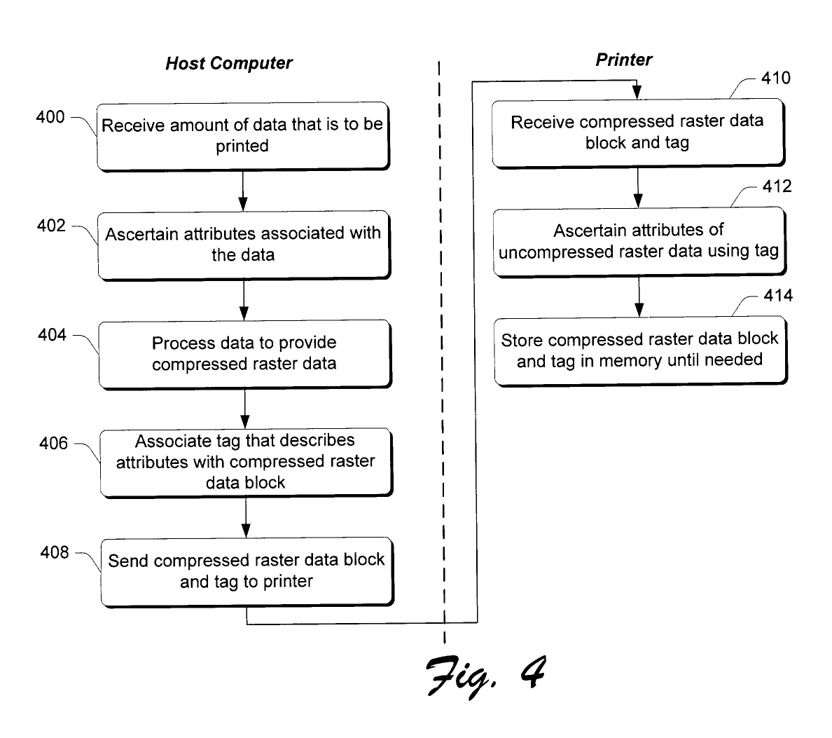

FIG. 4 is a flow diagram that describes steps in a method in accordance with one embodiment. The method can be implemented in any suitable hardware, software, firmware or combination thereof. In addition, the flow diagram is separated into two different portions-one labeled “Host Computer” to indicate acts that are performed by a host computer, and one labeled “Printer” to indicate acts that are performed by a printer.

Step 400 receives an amount of data that is to be printed. This step can be performed by a printer driver that resides on the host computer. Typically, the data is generated by an application, such as the one illustrated at 302 in FIG. 3. Step 402 ascertains attributes associated with the data. Exemplary attributes are described above. Step 404 processes the data to provide compressed raster data in the form of a data block. The compression processing that takes place can be any suitable compression processing that is typically utilized to provide raster data, as will be apparent to those of skill in the art. Step 406 associates a tag that describes data attributes with the compressed raster data block. Step 408 sends the compressed raster data block and its associated tag to a printer. Although not specifically shown, the method can return and repeat steps 400-408 multiple times for a particular print job. Doing so would provide an array of tag/block pairs, such as array 306 in FIG. 3.

On the printer side, step 410 receives the compressed raster data block and its associated tag. This step is typically performed multiple times per print job. Step 412 ascertains attributes of the decompressed raster data using the tag. Additionally, this step can ascertain, from the tag, attributes associated with the compressed raster data as well. Step 414 stores the compressed raster data block and tag (if desired) in memory until the compressed raster data block is needed. Examples of why a compressed raster data block might be needed are provided above.

### CONCLUSION

The above-described embodiments can reduce the need for printer firmware to decompress, process, and recompress raster data and can thus improve and make more efficient the printer's memory management and process scheduling. Additionally, economies can be achieved on the printer driver side as well. Additionally, economies are achieved by moving some of the image processing tasks to the host computer, where such processing can take place in a faster manner.

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A method comprising:
ascertaining one or more attributes associated with raster data that is intended for printing on a printer;
compressing the raster data to provide a compressed raster data block; and
associating, with the compressed raster data block, a tag that embodies the one or more attributes, at least one of said attributes being of a type such that without the tag, the printer would have to decompress the compressed raster data block in order to ascertain said one attribute.

2. The method of claim 1, wherein said acts of ascertaining, compressing, and associating are performed externally of the printer on which printing is intended.

3. The method of claim 1, wherein said acts of ascertaining, compressing, and associating are performed by a host computer that is operably connected with the printer on which printing is intended.

4. The method of claim 1, further comprising performing said acts of ascertaining, compressing, and associating multiple times to provide multiple tag/block pairs for an associated print job.

5. The method of claim 4, further comprising providing, as a part of at least some individual tags, a measure that can be used to ascertain a location of at least one other tag.

6. The method of claim 1, wherein said one or more attributes are selected from a group of attributes comprising: an attribute associated with a block dimension, an attribute associated with content of a block, an attribute associated with a color defined by the block.

7. One or more computer-readable media having computer-readable instructions thereon which, when executed by one or more processors, cause the one or more processors to:
ascertain one or more attributes associated with raster data that is intended for printing on a printer;
effect compression of the raster data to provide a compressed raster data block; and
associate, with the compressed raster data block, a tag that embodies the one or more attributes, at least one of said attributes being of a type such that without the tag, the printer would have to decompress the compressed raster data block in order to ascertain said one attribute.

8. The one or more computer-readable media of claim 7, wherein said one or more attributes are selected from a group of attributes comprising: an attribute associated with a block dimension, an attribute associated with content of a block, and an attribute associated with a color defined by the block.

9. The one or more computer-readable media of claim 7, wherein the instructions cause the one or more processors to process a print job in a manner that provides multiple tag/block pairs for the associated print job.

10. The one or more computer-readable media of claim 7, wherein the instructions cause the one or more processors to:
process a print job in a manner that provides multiple tag/block pairs for the associated print job; and
at least some individual tags comprising a measure that can be used to ascertain a location of at least one other tag.

11. A printer driver configured to:
ascertain one or more attributes associated with raster data that is intended for printing on a printer;
effect compression of the raster data to provide a compressed raster data block; and
associate, with the compressed raster data block, a tag that embodies the one or more attributes, at least one of said attributes being of a type such that without the tag, the printer would have to decompress the compressed raster data block in order to ascertain said one attribute.

12. The printer driver of claim 11, wherein said one or more attributes are selected from a group of attributes comprising: an attribute associated with a block dimension, an attribute associated with content of a block, and an attribute associated with a color defined by the block.

13. The printer driver of claim 11, wherein the printer driver is configured to process a print job in a manner that provides multiple tag/block pairs for the associated print job.

14. The printer driver of claim 11, wherein the printer driver is configured to process a print job in a manner that provides multiple tag/block pairs for the associated print job, at least some individual tags comprising a measure that can be used to ascertain a location of at least one other tag.

15. An apparatus comprising
a computer; and
a computer-readable medium associated with said computer, the medium having instructions thereon for:
ascertaining one or more attributes associated with raster data that is intended for printing on a printer;
compressing the raster data to provide a compressed raster data block; and
associating, with the compressed raster data block, a tag that embodies the one or more attributes, at least one of said attributes being of a type such that without the tag, the printer would have to decompress the compressed raster data block in order to ascertain said one attribute.

16. The apparatus of claim 15, wherein the instructions comprise instructions for processing a print job in a manner that provides multiple tag/block pairs for the associated print job.

17. The apparatus of claim 15, wherein the instructions comprise instructions for processing a print job in a manner that provides multiple tag/block pairs for the associated print job, at least some individual tags comprising a measure that can be used to ascertain a location of at least one other tag.

18. The apparatus of claim 15, wherein said one or more attributes are selected from a group of attributes comprising: an attribute associated with a block dimension, an attribute associated with content of a block, an attribute associated with a color defined by the block.

19. A method comprising:
receiving an amount of raster data that is to be printed on a printer;
ascertaining one or more attributes associated with the data, said attributes being selected from a group of attributes comprising: an attribute associated with a data block dimension, an attribute associated with content of the data block, and an attribute associated with a color defined by the data block;
processing the data to provide compressed raster data in the form of a compressed raster data block;
associating a tag with the compressed raster data block that describes said attributes; and
sending the compressed raster data block and its associated tag to a printer for printing.

20. One or more computer-readable media having computer-readable instructions thereon which, when executed by one or more processors, cause the one or more processors to:
receive an amount of data that is to be printed on a printer;
ascertain one or more attributes associated with the data, said attributes being selected from a group of attributes comprising: an attribute associated with a data block dimension, an attribute associated with content of the data block, an attribute associated with a color defined by the data block;
process the data to provide compressed raster data in the form of a compressed raster data block;
associate a tag with the compressed raster data block that describes said data attributes; and
send the compressed raster data block and its associated tag to a printer for printing.

21. The one or more computer-readable media of claim 20, wherein at least one of said attributes associated with a data block dimension comprises an decompressed block size.

22. The one or more computer-readable media of claim 20, wherein at least one of said attributes associated with a data block dimension comprises an decompressed block size, said block size comprising a width and height of the block.

23. The one or more computer-readable media of claim 20, wherein at least one of said attributes associated with the content of a data block comprises whether or not the block contains text.

24. The one or more computer-readable media of claim 20, wherein at least one of said attributes associated with the content of a data block comprises whether or not the block contains image data.

25. The one or more computer-readable media of claim 20, wherein at least one of said attributes associated with the content of a data block comprises whether the block contains all white.

26. The one or more computer-readable media of claim 20, wherein at least one of said attributes associated with the color defined by the data block comprises whether the block contains process colors.

27. The one or more computer-readable media of claim 20, wherein one or more of the tags contain a measure associated with a location of at least one other tag.

28. A method comprising:
receiving, with a printer, at least one compressed raster data block and an associated tag, said tag embodying one or more attributes associated with decompressed raster data that corresponds to the one compressed raster data block, at least one of said attributes being of a type such that without the tag, the printer would have to decompress the compressed raster data block in order to ascertain said one attribute;
without decompressing the one compressed raster data block, ascertaining attributes of the decompressed raster data using the tag; and
storing the compressed raster data block in printer memory until the compressed raster data block is needed.

29. The method of claim 28, wherein said act of receiving comprises receiving multiple tag/block pairs.

30. The method of claim 28, wherein said act of receiving comprises receiving multiple tag/block pairs, at least some of the tags containing information that enables the printer to deserialize its processing of the compressed raster data blocks.

31. The method of claim 28, wherein said act of receiving comprises receiving multiple tag/block pairs, at least some of the tags containing information that enables the printer to deserialize its processing of the compressed raster data blocks, said information comprising information on the location of at least one other tag.

32. The method of claim 28, wherein said one or more attributes are selected from a group of attributes comprising: an attribute associated with a block dimension, an attribute associated with content of a block, an attribute associated with a color defined by the block.

33. A printer comprising:
one or more processors;
memory;
instructions stored in the memory which, when executed by the one or more processors, cause the one or more processors to:
receive at least one compressed raster data block and an associated tag, said tag embodying one or more attributes associated with decompressed raster data that corresponds to the one compressed raster data block, at least one of said attributes being of a type such that without the tag, the printer would have to decompress the compressed raster data block in order to ascertain said one attribute;
without decompressing the one compressed raster data block, ascertain attributes of the decompressed raster data using the tag; and
store the compressed raster data block in memory until the compressed raster data block is needed.

34. The printer of claim 33, wherein said instructions cause the processors to receive multiple tag/block pairs for a single print job.

35. The printer of claim 33, wherein said instructions cause the processors to receive multiple tag/block pairs for a single print job, at least some of the tags containing information that enables the printer to deserialize its processing of the compressed raster data blocks.

36. The printer of claim 33, wherein said instructions cause the processors to receive multiple tag/block pairs for a single print job, at least some of the tags containing information that enables the printer to deserialize its processing of the compressed raster data blocks, said information comprising information on the location of at least one other tag.

37. The printer of claim 33, wherein said one or more attributes are selected from a group of attributes comprising: an attribute associated with a block dimension, an attribute associated with the content of a block, an attribute associated with a color defined by the block.
